(19) United States
(12) Patent Application Publication
(10) Pub. No.: US 2026/0304586 A1
(43) Pub. Date: Oct. 1, 2026

(54) ADAPTER FOR CONSUMABLE ELEMENTS OF A PLASMA TORCH

(71) Applicant: TEC.MO S.R.L., Pianoro (BO) (IT)

(72) Inventors: Giorgio Bassi, Pianoro (IT); Filippo Bassi, Pianoro (IT)

(21) Appl. No.: 19/483,449

(22) PCT Filed: May 22, 2024
(86) PCT No.: PCT/IB2024/054981

§ 371 Date: Nov. 11, 2025

(30) Foreign Application Priority Data
May 19, 2023 (IT) 102023000010248

(51) Int. Cl. H05H 1/34

(52) U.S. Cl. CPC H05H 1/3423

(57) ABSTRACT

An adapter for consumable elements (C) of a plasma torch (T), the adapter (1) comprising:—a hollow outer body (3);—a hollow inner body (5) at least partially inserted into the outer body (3) and locked thereto, fixable to a coupling seat (A) of the torch (T) and bearing a joint (6) for the consumable elements (C);—a hollow insulating element (7) open at the ends and slidably inserted into the inner body (5);—a conductive element (9) constrained to the insulating element (7) and which, in an assembled condition (M) of the adapter (1) wherein this is locked to the torch (T) at a mounting end (11) of the adapter (1) and the consumable elements (C) are locked to an apical end (13) of the adapter (1) opposite to the mounting end (11), is assigned to put into electrical communication a power supply pole (P) of the torch (T) with an electrode (E) of the consumable elements (C). The outer body (3), the inner body (5), the insulating element (7) and the conductive element (9) are developed along the same longitudinal axis (X). The conductive element (9) has a bottom (19) assigned to contact with the power supply pole (P) in the assembled condition (M). The conductive element (9) is provided with, at its own one proximal end (15), at least two fins (17) perpendicular to the longitudinal axis (X) and angularly equally spaced, and assigned, in the assembled condition (M), to contact with an activation sensor (S) of the torch (T), where the bottom (19) is positioned between the fins (17) and longitudinally aligned or staggered with respect to the latter.

### TECHNICAL FIELD

The present invention falls within the sector of plasma torches and refers in particular to an adapter for consumable elements of a plasma torch, in particular of the type with contact i.e. pneumatic trigger.

### PRIOR ART OF THE INVENTION

There is a known set of consumable elements for a plasma torch comprising at least a nozzle, an almost cylindrical diffuser made of insulating material, an electrode at least partially inserted and longitudinally sliding within the diffuser, a passage for the gas between the electrode and the nozzle, a contact element intended to place the electrode in electrical communication with an electric power supply, and an elastic element of conductive material acting in compression between the contact element and the electrode. The electrode has a distal end at the nozzle and the opposite proximal end connected to the elastic element.

There is also another known set of consumable elements without the elastic element, this being associated with the electrical power supply, with the proximal end of the electrode pressing on this elastic element when the set of consumable elements is mounted on the torch.

In both of said types of known sets, the proximal edge of the diffuser bears a crenellated crown with one or more protrusions that protrude longitudinally. When the set of consumable elements is mounted on the torch, these protrusions detect a torch activation sensor, for example they press a switch that closes a power circuit, otherwise disabled for safety reasons.

The ignition of the plasma using the known set of consumable elements requires that initially one end of the electrode is in contact with the inside of the nozzle and that the opposite end of the electrode is kept separate from the contact element or from the electrical power supply by means of the elastic element. An electric current is passed from the power supply through the elastic element, the electrode and the nozzle. A pressurized gas is then introduced into the passage between the electrode and nozzle towards the nozzle exit hole, and the pressure that develops in said passage separates the electrode from the nozzle, moving it longitudinally away against the elastic force of the elastic element until it strikes against the contact element or the electrical power supply. An arc discharge develops between the electrode and nozzle and ionizes the gas exiting the nozzle, giving rise to a jet of at least partially ionized gas, i.e. plasma.

Document EP1992206 B1 discloses an electrode for contact ignition plasma torch comprising a conductive body and a resilient element which is configured to pass the ignition current between the power supply and the electrode.

Document EP2442625 B1 discloses a system of expendable components for a contact ignition plasma torch comprising a nozzle, a resilient element, a longitudinally movable electrode, a plasma chamber defined by electrode and nozzle, an electrical contact fixed with respect to the chamber for the plasma and electrically connected to an electric power supply of the torch. During ignition, a conductive element, coinciding with the resilient element or separated from it, facilitates the passage of the ignition current, where the resilient element keeps the electrode detached from the electrical contact. During the operation of the torch, the gas in the plasma chamber pushes on the electrode, overcoming the force of the resilient element, and places the electrical contact in physical and electrical contact with the electrode and power supply.

Document EP2442626B1 discloses an electrode assembly for a contact ignition plasma torch comprising an electrode body slidable in a torch body, a conductive contact element, and an electrically conductive or insulating resilient element coupled to a conductive component. The conductive resilient element is placed between the electrode body and the contact element; the conductive component pushes the electrode body towards its distal end. During ignition, the contact element and the electrode body are not in contact, and the priming current is passed by the conductive resilient element or the conductive component. In steady state, the contact element is in contact with a proximal end of the electrode body, so that at least part of the current passes from the power supply to the electrode body through the contact element.

Document EP2801244B2 discloses a component for a plasma torch with contact ignition comprising an electrode body, a hollow body defining a channel which slidably houses the electrode body, a first contact element arranged in the hollow body, a second contact element arranged in the hollow body and movable with respect to the first contact element and having first, second and third surfaces. A resilient element pushes between the first contact element and the first surface of the second contact element, and is intended to pass the ignition current to the electrode body. In steady state, the second surface is in contact with the first contact element, and the third surface is in contact with the electrode body.

Document EP3141090B1 discloses a replaceable cartridge for a plasma torch comprising a cartridge body, an electrode and a spring element for contact ignition. The cartridge body has first and second sections joined to form a hollow chamber in which the electrode is housed. The spring element pushes the electrode towards the second section. The spring element is integrated directly into the cartridge and is designed not to be separable or removable from it.

Document EP3454627A1 discloses a diffuser for a contact ignition plasma torch comprising a hollow body equipped with one or more gas passages between its external and internal surfaces, an electrode body, and a resilient element intended to pass to the electrode body at least an ignition current. The resilient element includes a spring and a distinct contact surface including an annular washer attached to the spring to facilitate contact with the electrode body. A shoulder portion keeps the resilient element within the hollow body.

Document EP3473370B1 discloses a consumable cartridge for a plasma torch comprising an external component with a hollow body, and an internal component having a crown, an electrode and a diffuser which houses the electrode. The crown is associated with the proximal end of the diffuser. The internal component is at least partially surrounded by the external hollow body. A raised portion extends from the crown or diffuser to contact and activate a sensor inside the torch following installation of the cartridge onto the torch head.

Document WO2015/172142A1 discloses a plasma torch cartridge shell comprising a thermally conductive shell body, having a metal component configured to connect to first and second consumable components. The body shell surrounds at least a portion of the second consumable component. Passages cut through the body connect its internal and external surfaces to impart a flow pattern around the second consumable component.

A disadvantage of the known sets of consumable elements is that the protrusions of the diffuser crown are brittle and easy to break or fracture when mounting the set of consumable elements onto a torch.

Another disadvantage is that the crenellated crown of the diffuser limits the flow of gas between the torch and the nozzle.

A further disadvantage consists in the fact that the contact element overheats quickly due to the high electric current passing through it.

Another disadvantage consists in the fact that during ignition all or most of the electric current is conducted to the electrode by the elastic element, which constitutes a notable electrical resistance, limiting this current and overheating easily.

A further disadvantage consists in the fact that the known sets of consumable elements are applicable only to plasma torches having an activation sensor, and vice versa that plasma torches having an activation sensor require the use of sets of consumable elements in which the diffuser is equipped with a crenellated crown that can contact with such sensor, not working with other known sets of consumable elements lacking such a crenellated crown.

Another disadvantage consists in the fact that the assembly operation of the known sets of consumable elements on a plasma torch is particularly laborious, as particular attention is required to precisely align one of the protrusions with the torch activation sensor.

### DISCLOSURE OF THE INVENTION

An object of the present invention is to propose an adapter for consumable elements of a plasma torch which allows known sets of consumable elements, even without a crenellated crown of the diffuser, to be mounted on a plasma torch with an activation sensor.

A further object of the present invention is to propose an adapter that can be associated with a plasma torch and left there when the consumable elements are replaced, where the torch activation sensor is disabled in the absence of such consumable elements mounted on the adapter.

Another object of the present invention is to propose an adapter in which the contact element of the activation sensor is robust and resistant to fractures and breakages, and does not limit the gas flow.

A further object of the present invention is to propose an adapter in which the electrical conduction is extremely high, allowing the passage of very high currents, and in which the cooling of the conductive parts is extremely efficient, too.

### BRIEF DESCRIPTION OF THE DRAWINGS

The characteristics of the invention are highlighted below with particular reference to the attached drawings in which:

FIG. 1 illustrates a side view of the adapter for consumable elements of a plasma torch object of the present invention;

FIG. 2 illustrates a top view of the adapter of FIG. 1;

FIG. 3 illustrates a sectional side view along plane III-III of the adapter of FIG. 2;

FIG. 4 illustrates a sectional axonometric view along plane IV-IV of the adapter of FIG. 2;

FIGS. 5 to 8 illustrate sectional side views of a sequence of assembly of the adapter of FIG. 1 onto a plasma torch and of a set of consumable elements on such adapter, where in FIG. 8 the adapter is in a steady-state condition;

FIGS. 9 and 10 illustrate exploded axonometric views of the adapter of FIG. 1;

FIG. 11 illustrates an axonometric view of a variant of a distal portion of a conductive element of the adapter of FIG. 1;

FIG. 12 illustrates a top view of the distal portion of FIG. 11;

FIG. 13 illustrates a side and partially sectional view of the distal portion of FIG. 11 and of a proximal portion associated therewith making up the conductive element;

FIG. 14 illustrates an exploded and partially sectional side view of the conductive element of FIG. 13;

FIG. 15 illustrates a sectional side view along plane III-III of the adapter of FIG. 2 in the variant of the distal portion of FIG. 11;

FIG. 16 illustrates an sectional axonometric view along plane IV-IV of the adapter of FIG. 2 in the variant of the distal portion of FIG. 11;

FIG. 17 illustrates a sectional side view along plane III-III of the adapter of FIG. 2 in a second embodiment thereof;

FIG. 18 illustrates a sectional axonometric view along plane IV-IV of the adapter of FIG. 2 in its second embodiment;

FIGS. 19 to 22 illustrate sectional side views of an assembly sequence of the second embodiment of the adapter object of the present invention onto a plasma torch and of a set of consumable elements onto this adapter;

FIGS. 23 and 24 illustrate exploded axonometric views of the adapter of FIG. 17;

FIG. 25 illustrates a first variant of the fins of FIG. 3;

FIGS. 26 and 27 respectively illustrate top and side views of an optional contact element for the fins of the variant of FIG. 25;

FIG. 28 illustrates a second variant of the fins of FIG. 3;

FIGS. 29 and 30 respectively illustrate top and side views of an optional contact element for the fins of the variant of FIG. 28;

FIG. 31 illustrates a third variant of the fins of FIG. 3.

### BEST MODE TO CARRY OUT THE INVENTION

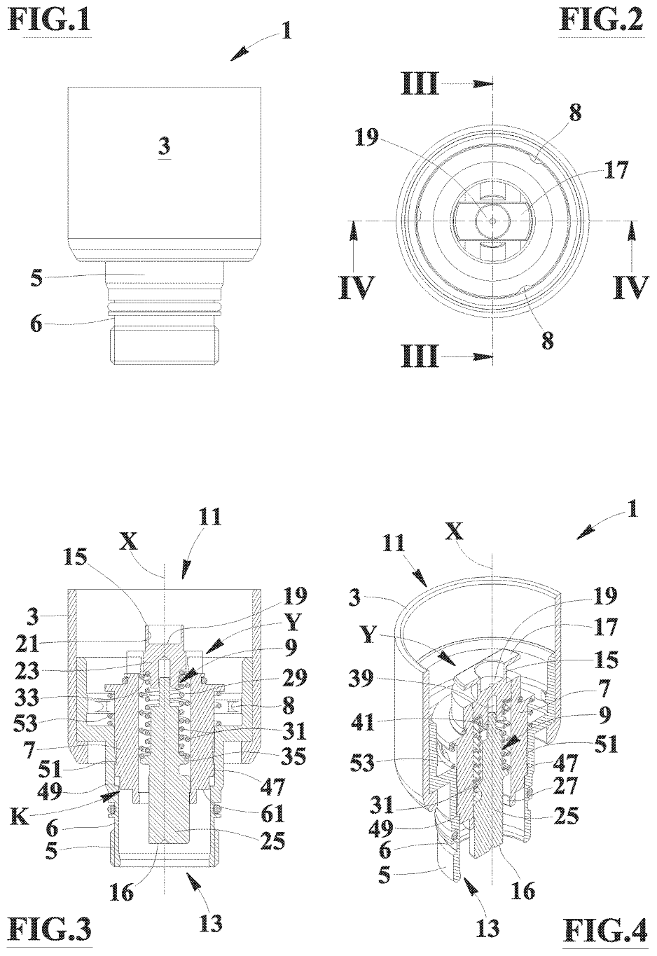

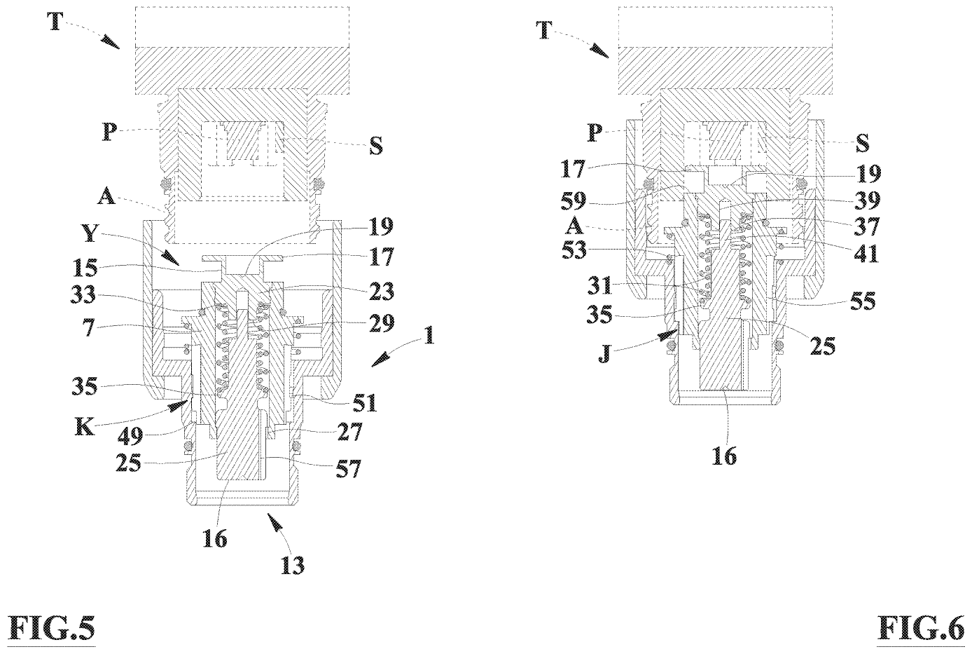

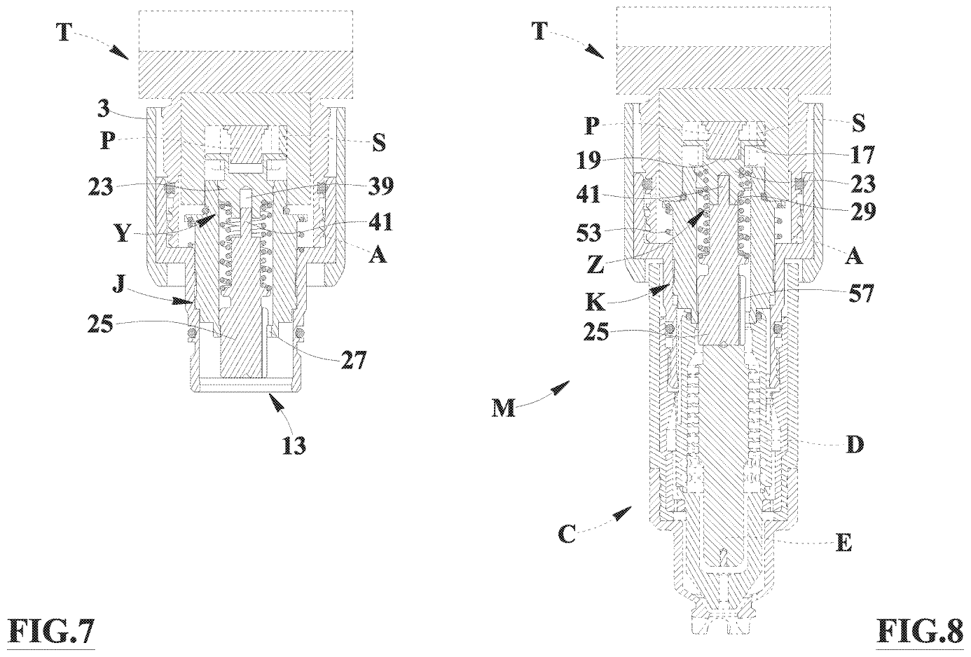

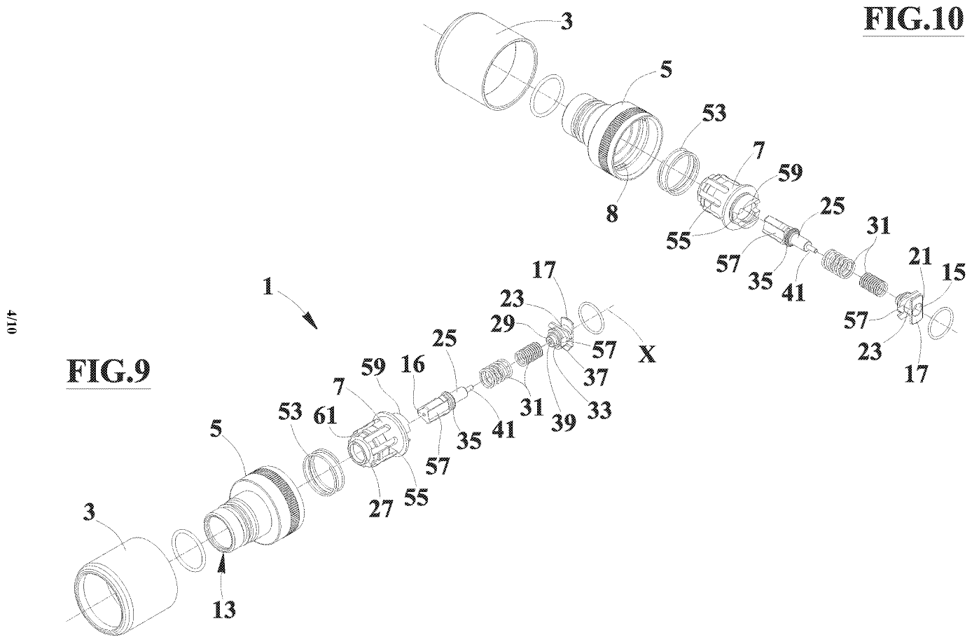

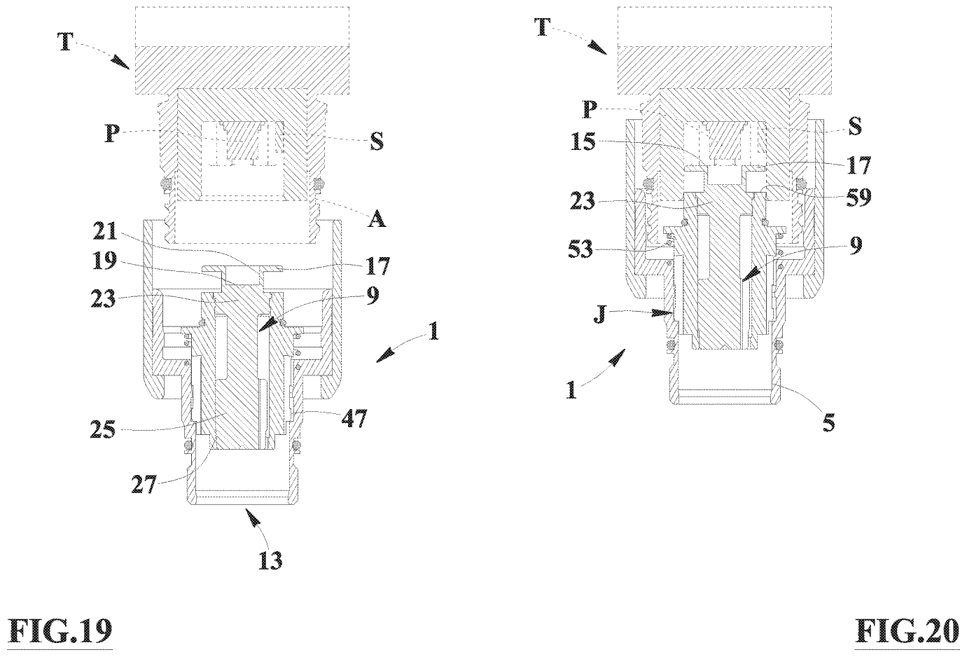

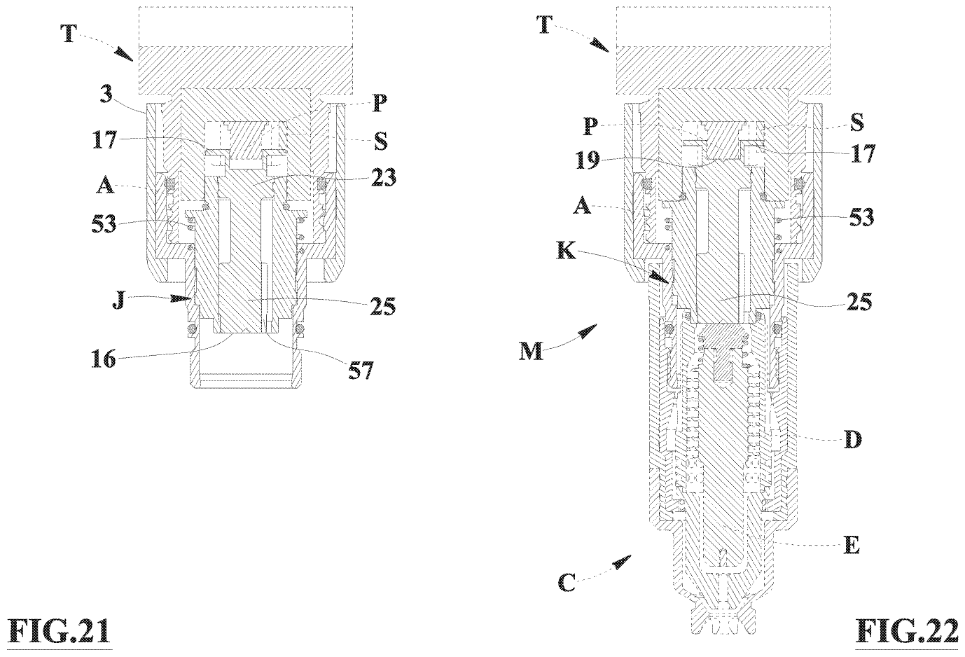

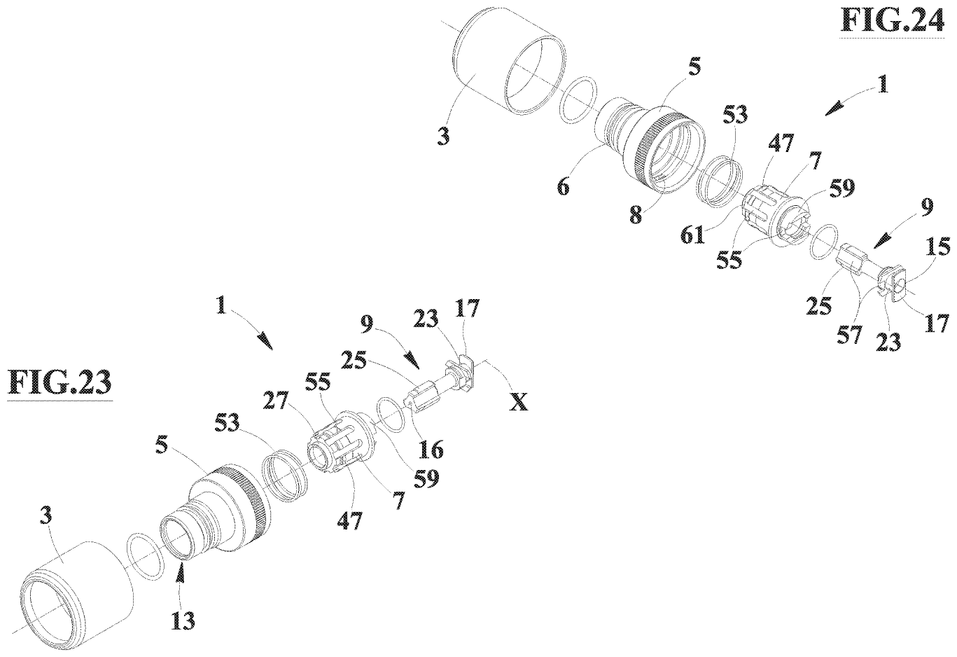

With reference to FIGS. 1 to 24, 1 indicates the adapter for consumable elements C of a plasma torch T object of the present invention.

The adapter 1 is intended to be applied to plasma torches T with pneumatic ignition or so-called blowback start.

The torch T, of a known type, comprises a handle equipped with a coupling seat A which is intended for the removable fastening of the adapter 1 to the torch T itself and within which the following are housed:
a power supply pole P, such as for example a connector or conductive pin connected to an electrical power supply;
the exit of a duct connected to a compressed gas reserve;
a sensor S for activation of the torch T, for example of a mechanical pressure type, such as a switch or microswitch, of proximity, such as a photo switch or a Hall effect detector, or of an electrical contact type, connected to an enabling circuit of the torch T which signals when this contact S and the power supply pole P are electrically connected and/or at the same potential.

In general, said sensor S enables the operation of the torch T only when activated, and prevents its electrical supply when not activated to guarantee the safety of an operator of the torch T. Protrusions can notoriously be present inside the coupling seat A to function as a guide or pilot towards the sensor S.

The consumable elements C, of a known type, commonly include an electrode E with longitudinal development, an insulating diffuser element D which surrounds the electrode E, and a conductive nozzle N fixed to one end of the diffuser element D, with one or more passages for the gas between electrode E and nozzle N. These consumable elements C can be replaced individually, or they can be inserted into specific pre-assembled cartridges that can be replaced as a whole.

In the preferred embodiment, the adapter 1 essentially comprises:
an almost cylindrical or tubular hollow outer body 3, preferably made of electrically and thermally insulating material;
a hollow inner body 5, at least partially inserted into the outer body 3 or inserted into it along its own entire length, and blocked or in a single body therewith, fixable to the coupling seat A of the torch T, and bearing a joint 6 for the consumable elements C;
a hollow insulating element 7 with an almost cylindrical or tubular development and open at its ends, and slidably inserted into the inner body 5;
a conductive element 9 mechanically snap-fit locked or constrained in other ways to the insulating element 7 and which, in an assembled condition M of the adapter 1 in which this is locked to the torch T on the side of a mounting end 11 of the adapter 1 itself and in which the consumable elements C are blocked at an apical end 13 of the adapter 1 opposite to the mounting end 11, is assigned to put the power supply pole P of the torch T into electrical communication with the electrode E of the consumables elements C.

The outer body 3, the inner body 5, the insulating element 7 and the conductive element are coaxial and develop along the same longitudinal axis X. In the assembled condition M, this longitudinal axis X also coincides with the axis of the coupling seat of the torch T and with the longitudinal axis of the consumable elements C, in particular of the electrode E.

The coupling seat A is generally a cylindrical seat provided with a single- or multi-start thread; consequently, the inner body 5 is provided with one or more complementary threads or teeth 8 such as to allow locking by screwing the adapter 1 to the coupling seat A of a predetermined torch T.

Similarly, the joint 6 is for example a thread or a track for a snap-fit or bayonet attachment, depending on the type and shape of the corresponding portion of the specific consumable elements C intended for coupling with the adapter 1.

The conductive element 9, made of electrically conductive material such as for example copper, brass or other metal or metal alloy, extends longitudinally between a proximal end 15 and an opposite distal end 16 of the conductive element 9 itself. In the assembled condition M, the proximal end 15 faces or is close to the torch T and is insinuated or inserted into the coupling seat A, whereas the distal end 16 faces the consumable elements C.

At or near to the proximal end 15, the conductive element 9 has two fins 17, i.e. tongues, tabs, flaps or flat shelves, perpendicular to the longitudinal axis X and angularly equally spaced, protruding diametrically from the conductive element 9 itself.

In said assembled condition M, the fins 17 are assigned to come into contact with the activation sensor S of the torch T; in particular, in the case of multi-start threaded coupling seat A, the particular fin 17 which actually contacts with the sensor S, enabling the operation of the torch T, depends on the initial screwing angle of the adapter 1 on the torch T.

Preferably, the fins 17 are in a single body and of the same conductive material as the remaining part of the conductive element 9. The ends of the fins 17 are rounded with a radius equal to or smaller than the internal radius of the coupling seat A of the torch T, within the which they rotate around the longitudinal axis X during assembly and disassembly of the adapter 1 with the torch T. The thickness of the fins 17 is such to make them sufficiently stiff for operating the sensor S, for example comprised between 0.2 mm and 10 mm, preferably about 1 mm.

In a variant of the conductive element 9, the fins 17 are more than two in number, also depending on the number of starts of the threading of the coupling seat A, so that whatever the angle or orientation of the adapter 1 with respect to the coupling seat A at the beginning of the screwing, once the fastening is completed a fin 17 certainly meets the sensor S enabling the operation of the torch T. For example, the conductive element 9 can be equipped with three fins 17 angularly spaced by 120°.

The conductive element 9 has a bottom 19 arranged at the proximal end 15 between the fins 17 and centered on the longitudinal axis X, and which in the assembled condition M is assigned to contact with the power supply pole P of the torch T.

The proximal end 15 preferably has a seat 21 whose shape is almost complementary to the shape of the power supply pole P, concave in the distal direction, and whose bottom end coincides with said bottom 19. The bottom 19 is therefore longitudinally staggered in a distal direction, i.e. towards the distal end 16, with respect to the segment joining the fins 17.

For example, if the power supply pole P is of the cylindrical pin type, the seat 21 is a cylindrical cavity with a diameter equal to or slightly greater than the diameter of said pin. An almost equal diameter also allows contact between the lateral wall of the seat 21 and the power supply pole P, consequently increasing the electrical conductivity of this contact. The entrance edge of the seat 21 can be beveled to form a pilot opening that facilitates the coupling between the seat 21 and the power supply pole P during the assembly of the adapter 1 on the torch T.

A variant of the conductive element 9 provides that the bottom 19 is longitudinally aligned with the fins 17, making up a flat abutment seat for the power supply pole P in the assembled condition M.

In another variant, the bottom 19 is offset or staggered with respect to the fins 17 but in the opposite direction to the distal end 16, i.e. in the direction of the torch T in the assembled condition M. In general, the longitudinal offset between the fins 17 and the bottom 19 corresponds to the longitudinal component of the distance between the sensor S and the power supply pole P of the specific torch T on which the adapter 1 is intended to be mounted, so that in the assembled condition M the couplings between a fin 17 and the sensor S and between the bottom 19 and the power supply pole P are simultaneously achieved.

The conductive element 9 comprises a proximal portion 23, comprising the proximal end 15, and an opposite distal portion 25, comprising the distal end 16. Said portions 23, 25 are longitudinally aligned, and in the assembled condition M they are facing and positioned in contact with the power supply pole P of the torch T and with the electrode E of the consumable elements C, respectively.

Preferably, the proximal portion 23 and the distal portion 25 are distinct components, i.e. they are distinct and independent from each other. The proximal portion 23 is integral with the insulating element 7 to which it is blocked, whereas the distal portion 25 is slidable along the internal walls of the cavity of the insulating element 7, which keeps it coaxial with the longitudinal axis X. The proximal 23 and distal 25 portions, although mutually movable, are always in electrical connection and preferably in direct contact with each other.

In particular, the sliding of the distal portion 25 is longitudinally limited between a rest condition Y of the adapter 1, wherein the distal portion 25 is maximally spaced from the proximal portion 23 and rests in contact against a block frame 27 protruding internally from the insulating element 7, and a steady-state condition Z of the adapter 1, wherein the distal portion 25 is maximally close to the proximal portion 23 and is in contact against a stop 29 of the latter, coinciding for example with a junction end 37 opposite to the proximal end 15 and perpendicular to the longitudinal axis X. Said block frame 27 and stop 29 thus constitute opposite stroke ends for the longitudinal translation of the distal portion 25.

At least one spring 31, preferably two helical springs 31, surround the distal portion 25 at least in the longitudinal section thereof facing the proximal portion 23 and are longitudinally constrained in compression with their ends respectively between a first shoulder 33 of the proximal portion 23 and a second shoulder 35 of the distal portion 25, acting in compression between said two portions 23, 25 of the conductive element 9 with a longitudinal elastic force directed to move the distal portion 25 away from the proximal portion 23.

The two springs 31 are coaxial and preferably antiparallel, with one spring 31 of smaller diameter inside the other spring 31 of larger diameter. The opposite momentums of the two springs 31 ensure that the distal portion 25 simply translates longitudinally without rotating along its own axis, avoiding the possibility of debris, splinters or other wear damages caused by the rubbing of the distal end 16 against the electrode E.

The elastic constant of the springs 31, determined by the combination of material, thickness and geometry of the springs 31 themselves, is such that the springs 31 can be pushed and compressed by the distal portion 25 due to the gas pressure that develops between electrode E and nozzle N in the steady-state operating condition of the plasma torch T.

The springs 31 are preferably made or coated with electrically insulating material, so that, as there is no electric current passing through them, they do not heat up due to the Joule effect and do not undergo variations in their elastic properties.

Alternatively, the springs 31 are made of a conductive material, for example steel, contributing to the conduction of the electric current from the power supply pole P to the electrode E. If it is intended to prevent the conductive springs 31 from being traveled by the electric current, it is possible to insert an insulation between the springs 31 and the proximal 23 and distal 25 portions of the conductive element 9, for example sheath and/or washer insulating elements.

A variant of the conductive element 9 provides that the springs 31 are in a different number and/or of a different type, for example leaf or cup springs, in any case blocked between the first shoulder 33 and the second shoulder 35.

To allow electrical conduction between the two portions 23, 25 of the conductive element 9 both in the steady-state condition Z and in the rest condition Y, the proximal portion 23 preferably has a longitudinal seat 39 at its junction end 37, opposite to the proximal end 15 and facing the distal portion 25. The distal portion 25 in turn has a longitudinal pin 41 of a cylindrical or in any case elongated shape and coaxial with the longitudinal axis X, with a maximum diameter almost equal to the diameter of this longitudinal seat 39, at least partially inserted into the latter and sliding with contact along it. The longitudinal pin 41, coupled to the longitudinal seat 39, is assigned to ensure and maintain a direct physical and electrical connection between the proximal 23 and distal 25 portions.

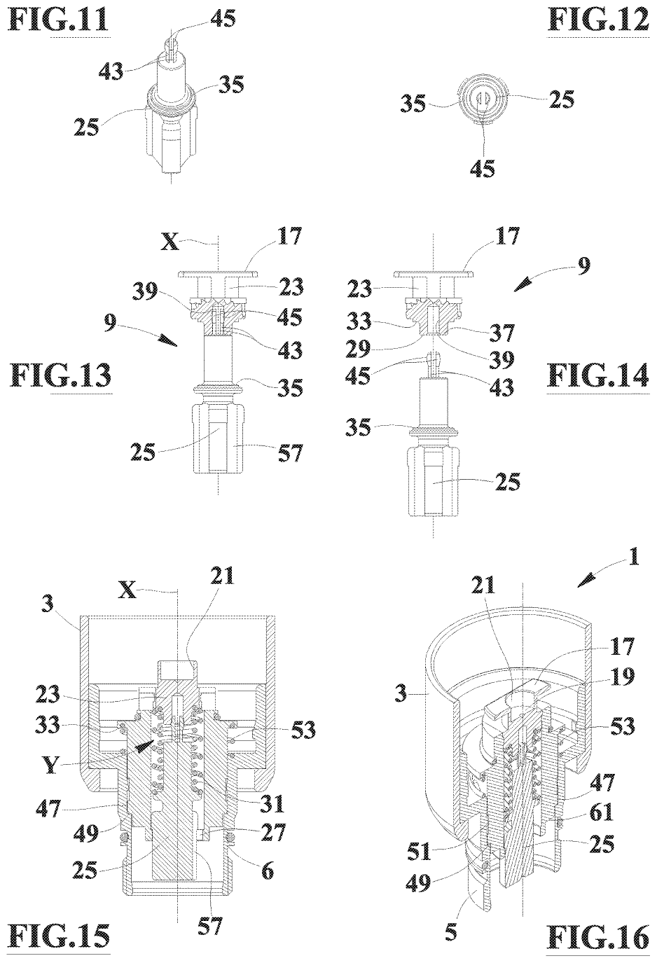

In a variant of the distal portion 25 of the conductive element 9, illustrated in particular in FIGS. 11 to 16, the longitudinal pin 41 is longitudinally divided along a plane passing through the longitudinal axis X into two arms 43, on opposite sides of said plane or axis, and each one ending in a respective lobed end 45, of a beveled, bulged or rounded shape, for example spherical or ovoid.

The arms 43 exhibit elasticity in a radial direction, i.e. transverse to the longitudinal axis X, such that their respective lobed ends 45 always remain elastically pushed against the internal walls of the longitudinal seat 39, ensuring the electrical contact between the proximal portion 23 and the distal portion 25 in all conditions and during the sliding of the longitudinal pin 41 along the longitudinal seat 39.

Alternatively, the longitudinal pin 41 can be divided along several longitudinal planes into more than two arms 43, also depending on the diameter of the longitudinal seat 39 or of the longitudinal pin 41 itself.

The insulating element 7, on its external lateral surface, preferably comprises a collar 47 in continuous or intermittent relief, and is slidable along and within the inner body 5 between a retracted position J, wherein said collar 47 abuts with a distal shoulder 49 of the inner body 5, and an extended position K, wherein said collar 47 abuts with a proximal shoulder 51 of the inner body 5. These distal 49 and proximal 51 shoulders are raised abutments internally protruding from the inner body 5 itself, constituting opposite stroke ends for the longitudinal movement of the insulating element 7.

A resilient element 53, such as a helical spring, is associated or wrapped around the insulating element 7, with its ends pressing respectively against an internally protruding step of the inner body 5 and against an externally raised frame of the insulating element 7. Said resilient element 53 is therefore bound in compression between the inner body 5 and the insulating element 7 and acts between them with a longitudinal elastic force directed towards the extended position K of the insulating element 7 itself.

Advantageously, the resilient element 53 is intended to facilitate the screwing of the adapter 1 onto the torch T and the centering of the fins 17 with respect to the sensor S. In fact, the resilient element 53 keeps the fins 17 elastically pushed towards the extended position K ; when, during screwing, a fin 17 encounters obstacles such as the sensor S and/or protrusions, for example guides or pilots, inside the coupling seat A of the torch T, these obstacles push said fin 17 and consequently the insulating element 7 towards the retracted position J, allowing the fin 17 to overcome the obstacle and engage the correct pilot track insinuating towards the sensor S.

The fins 17 can have slightly beveled edges in order to facilitate such sliding movements during centering.

Preferably, the insulating element 7, made of resin, plastic or other electrically and possibly also thermally insulating material, has longitudinal and/or transversal grooves 55 on its outer lateral surface. The conductive element 9 has longitudinal or longitudinally developing passages 57 on its lateral surface. In the assembled condition M, said grooves 55 and passages 57 are assigned to allow the flow of gas between the torch T and the consumable elements C for the operation of the torch T itself.

For example, the insulating element 7 is provided with a series of equally spaced longitudinal grooves 55 along its outer lateral surface, for the flow of gas outside the insulating element 7, and with two diametrically opposed transverse grooves 55 which pass through its lateral surface at the junction with the proximal portion 23 of the conductive element 9, to allow the flow of gas also towards the inside of the insulating element 7.

Within the insulating element 7, the passages 57 dug in the conductive element 9 allow the gas to get from the proximal end 15 to the distal end 16 of the latter up to the consumable elements C.

Preferably, said two transversal grooves 55 are obtained in the insulating element 7 in positions transversely perpendicular to the segment joining the fins 17, so that the fins 17 themselves interfere with little or no influence on the flow of gas from the torch T to the grooves 55 and towards the inside of the insulating element 7.

The insulating element 7 has a first end 59 and an opposite second end 61. The proximal end 15 of the conductive element 9 protrudes longitudinally from said first end 59 in the direction of the torch T in the assembled condition M, with the fins 17 spaced apart from the latter or separated from it by an empty volume. The distal end 16 of the conductive element 9 protrudes longitudinally from said second end 61 in the direction of the consumable elements C in the assembled condition M. The block frame 27 is obtained near or at the second end 61.

In the assembled condition M, the second end 61 of the insulating element 7 is intended to be connected to the diffuser element D of the consumable elements C. This connection is preferably gas-tight, so as to completely isolate the flow of gas inside the insulating element 7 from the flow on its exterior. Gas tightness is achieved for example by means of an O-ring or other seal element.

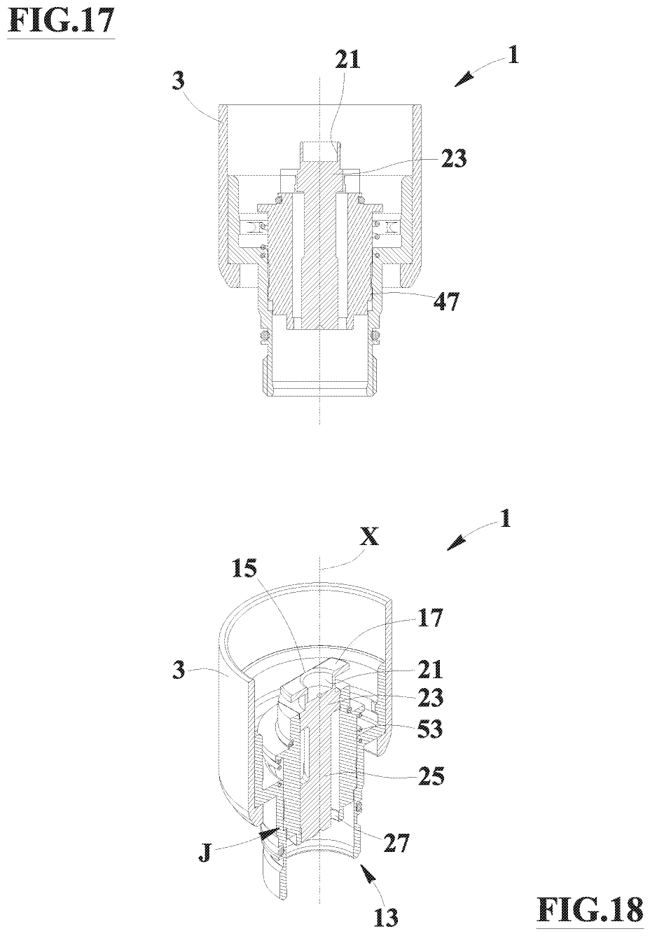

Now making particular reference to FIGS. 17 to 24, a second embodiment of the adapter 1 provides that the proximal portion 23 and the distal portion 25 of the conductive element 9 are in a single body and integral with each other, therefore immobile with respect to each other. The conductive element 9 is therefore free of springs 31 between the two portions 23, 25.

Said second embodiment is particularly suitable for the adaptation of consumable elements C in which the elastic element is included, which allows the electrode E to move during the pneumatic ignition of the arc discharge. In this type of consumable element C, the elastic element has one end associated with the proximal end of the electrode E and, in the assembled condition M, the opposite end is intended for contact with the distal end 16 of the distal portion 25, possibly through the interposition of further conductive parts, creating the electrical connection between the torch T and the electrode E. The conductive element 9 therefore remains stationary with respect to the insulating element 7 inside which it is blocked.

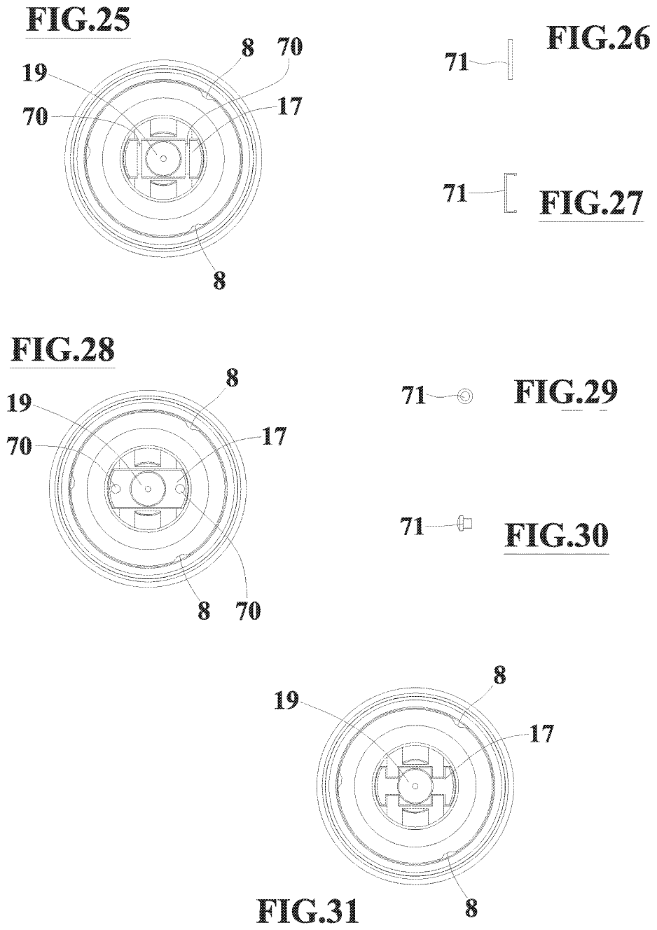

Referring now to FIGS. 25 and 28, the first and second variants of the adapter 1 provide that the distal portion of each fin 17 is provided with at least one fastening element 70.

Now also considering FIGS. 26, 27, 29 and 30, these variants prepare the adapter 1 for the optional adoption of a contact element 71 for each fin 17. Each contact element 71 is assigned to be fixed to a respective fastening element 70 of a fin to contact with the sensor S. The optional contact elements allow, where adopted, to compensate for any tolerances of the parts, to allow the adapter 1 to operate correctly even with different sensors S, and to provide a contact with the sensor S more or less rigid and adaptable to needs.

Each of the fastening elements 70 comprises at least one concavity obtained in, or through, the respective fin 17. This concavity has a shape complementary to a respective portion of the corresponding contact element 71 so as to allow the possible fixing of the latter to the respective fin 17.

In the first variant of the adapter 1, the concavity of the fin 17, which constitutes the fixing element 70, is in the shape of a transverse groove and the corresponding contact element 71 has the shape approximately of a staple to fit into the concavity protruding from the surface of the fin towards the sensor S.

In the second variant of the adapter 1, the concavity of the fin 17, which constitutes the fixing element 70, consists of a through hole and the corresponding contact element 71 has an approximately mushroom shape with a stem complementary to the through hole. The head of the mushroom protrudes from the fin 17 and is intended to meet with the sensor S. The part of the contact element 71 intended to meet with the sensor S can be solid or can consist of an elastic arm, for example in the shape of a limb of crossbow. The contact element 71 can be made of metallic material, electrically conductive or insulating plastic, elastomer or other elastic material.

The invention provides that each fin 17 is approximately rectangular in shape or, as envisaged by the third variant of the adapter 1 illustrated in FIG. 31, it can be approximately in the shape of a symmetrical hammer with the edge of the distal end in the shape of segment of circle or ellipse. Alternatively, each fin 17 can be approximately sickle-shaped or U-shaped or pendulum-shaped with the edge of the distal end in the shape of a segment of circle or ellipse. These conformations of the fin 17 make it easier to assemble and facilitate the coupling of the adapter 1 even in the event of tolerances or modifications of the parts to which it must be coupled.

1) Adapter for consumable elements (C) of a plasma torch (T), the adapter (1) comprising:
a hollow outer body (3);
a hollow inner body (5) at least partially inserted into the outer body (3) and locked thereto, fixable to a coupling seat (A) of the torch (T) and bearing a joint (6) for the consumable elements (C);
a hollow insulating element (7) open at ends thereof and slidably inserted into the inner body (5);
a conductive element (9) constrained to the insulating element (7) and that, in an assembled condition (M) of the adapter (1) is locked to the torch (T) at a mounting end (11) of the adapter (1) and the consumable elements (C) are locked to an apical end (13) of the adapter (1) opposite to the mounting end (11), is configured to put into electrical communication a power supply pole (P) of the torch (T) with an electrode (E) of the consumable elements (C);
the outer body (3), the inner body (5), the insulating element (7) and the conductive element (9) developing along a same longitudinal axis (X); the conductive element (9) having a bottom (19) configured to contact with the power supply pole (P) in the assembled condition (M); wherein the conductive element (9) has at a proximal end (15) thereof at least two fins (17) perpendicular to the longitudinal axis (X) and angularly equally spaced, and configured, in the assembled condition (M), to contact with an activation sensor(S) of the torch (T), where the bottom (19) is between the fins (17) and longitudinally aligned or staggered with respect to the fins (17).

2) The adapter according to claim 1, wherein the proximal end (15) of the conductive element (9) has a seat (21) having a shape that is almost complementary to a shape of the power supply pole (P), and having a bottom end that coincides with said bottom (19).

3) The adapter according to claim 1, wherein the conductive element (9) comprises a proximal portion (23), comprising the proximal end (15), and a distal portion (25) that are longitudinally aligned and that in the assembled condition (M) are pointed towards the torch (T) and towards the consumable elements (C), respectively.

4) The adapter according to claim 3, wherein the proximal portion (23) and the distal portion (25) are distinct components, where the proximal portion (23) is locked to the insulating element (7), and the distal portion (25) is slidable along a cavity of the insulating element (7) between a rest condition (Y) of the adapter (1), wherein the distal portion (25) is maximally spaced from the proximal portion (23) and a steady-state condition (Z) of the adapter (1), wherein the distal portion (25) is maximally close to the proximal portion (23); at least one spring (31) acts between the proximal portion (23) and the distal portion (25) with a longitudinal force aiming at moving the distal portion away from the proximal portion (23).

5) The adapter according to claim 4, wherein the proximal portion (23) has a longitudinal seat (39) at a junction end (37) of the proximal portion (23) opposite the proximal end (15), and the distal portion (25) has a longitudinal pin (41) slidable with contact along the longitudinal seat (39).

6) The adapter according to claim 5, wherein the longitudinal pin (41) is longitudinally divided into at least two arms (43) each one ending in a lobed end (45).

7) The adapter according to claim 3, wherein the proximal portion (23) and the distal portion (25) are in a single body.

8) The adapter according to claim 1, wherein the insulating element (7) comprises a collar (47) and is slidable along the inner body (5) between a retracted position (J), wherein the collar (47) abuts a distal shoulder (49) of the inner body (5), and an extended position (K), wherein the collar (47) abuts a proximal shoulder (51) of the inner body (5), with a resilient element (53) acting longitudinally between the inner body (5) and the insulating element (7) with an elastic force directed towards the extended position (K) of the insulating element (7).

9) The adapter according to claim 1, wherein the insulating element (7) has grooves (55) on an outer lateral surface thereof, and the conductive element (9) has passages (57) on a lateral surface thereof, said grooves (55) and passages (57) configured to allow the flow of gas between the torch (T) and the consumable elements (C).

10) The adapter according to claim 1, wherein the insulating element (7) has a first end (59), from which the proximal end (15) of the conductive element (9) protrudes with the fins (17) spaced from said first end (59), and a second end (61), from which a distal end (16) of the conductive element (9) opposite the proximal end (15) protrudes; said second end (61) configured for an airtight connection to a diffuser element (D) of the consumable elements (C) in the assembled condition (M).

11) The adapter according to claim 1, wherein the distal portion of each fin (17) is provided with at least one fastening element (70).

12) The adapter according to claim 1, comprising at least one contact element (71) for each fin (17) configured for fixation to a respective fastening element (70) and for contact with the sensor(S).

13) The adapter according to claim 12, wherein each fastening element (70) comprises at least one concavity obtained in, or through, a respective fin (17) and having a shape complementary to a respective portion of a corresponding contact element (71).

14) The adapter according to claim 13, wherein the concavity of the fastening element (70) has a shape of a transverse groove and the corresponding contact element (71) is shaped as a staple, or the concavity of the fastening element (70) consists of a through hole and the corresponding contact element (71) is shaped as a mushroom with a stem complementary to the through hole.

15) The adapter according to claim 1, wherein each fin (17) has a rectangular shape or is shaped as a hammer, a sickle, a “U” or a pendulum with an edge of the distal end in the shape of segment of a circle or of an ellipse.
